(19) United States
(12) Patent Application Publication
(10) Pub. No.: US 2015/0372755 A1
(43) Pub. Date: Dec. 24, 2015

(54) OPTICAL TRANSMITTING AND RECEIVING APPARATUS AND METHOD THEREOF BASED ON MULTICARRIER DIFFERENTIAL PHASE SHIFT KEYING

(71) Applicant: Electronics and Telecommunications Research Institute, Daejeon (KR)

(72) Inventors: Hwan Seok CHUNG, Daejeon-si (KR); Sun Hyok CHANG, Daejeon-si (KR)

(21) Appl. No.: 14/742,036

(22) Filed: Jun. 17, 2015

(30) Foreign Application Priority Data
Jun. 18, 2014 (KR) 10-2014-0074569

(51) Int. Cl. H04B 10/2513; H04B 10/2569; H04B 10/67; G02F 1/21; H04B 10/556

(52) U.S. Cl. CPC H04B 10/25133; G02F 1/21; H04B 10/5561; H04B 10/677; H04B 10/2569

(57) ABSTRACT

An optical transmitting apparatus based on multicarrier differential phase shift keying. The optical transmitting may include a multicarrier generator to output two or more optical signals, each of which has a different wavelength; two or more optical modulators to receive the two or more optical signals, respectively, which have been output from the multicarrier generator, wherein each of the two or more optical modulators modulates phases of the two or more received optical signals by electrical signals that are applied in pairs.

### CROSS-REFERENCE TO RELATED APPLICATION(S)

This application claims the benefit under 35 U.S.C. §119(a) of Korean Patent Application No. 10-2014-0074569, filed on Jun. 18, 2014, in the Korean Intellectual Property Office, the entire disclosure of which is incorporated herein by reference for all purposes.

### BACKGROUND

1. Field

The following description relates to an optical transmitting and receiving apparatus and method thereof, and more specifically to the optical transmitting and receiving apparatus with a multi-level modulation/demodulation function and an electrical dispersion compensation function, and method thereof.

2. Description of the Related Art

As well as a non-return-to-zero (NRZ) or return-to-zero (RZ) manner for simply switching an optical signal on/off according to electronic data, which is input in an optical method of transmitting high-speed modulation data, the following modulation methods are appearing: phase-shift key (PSK), quadrature phase-shift key (QPSK), and quadrature amplitude modulation (QAM), and the like, which modulate a phase of an optical signal.

The modulation methods of NRZ, RZ, and differential phase-shift key (DPSK), which map one bit to one symbol and transmit it, have problems of increasing the required bandwidth of the element as the transmission speed increases for each channel. Thus, a phase modulation-based multi-level modulation manner (e.g., QPSK and QAM, which map two or more bits to one symbol and transmit them), has an advantage in lowering the used bandwidth of an element. In addition, the used bandwidth of the element may be even lowered if at the same time when a symbol mapping rate is increased, each different signal is transmitted for every polarization of an optical signal, or two or more optical carriers are used.

There are the following manners to receive an optical signal with the modulated phase and restore the data: a coherent manner of directly detecting the phase of the optical signal, and a directly receiving method of converting a phase into a size.

The coherent manner is to, at a receiving terminal, mix an input signal and a laser that has the similar value to that of a transmitting terminal, and restore the data, and is mostly used along with polarization multiplexing. A representative modulation manner is dual polarization-quadrature phase shift keying (DP-QPSK). The DP-QPSK may reduce a symbol rate to a quarter of the bitrate, and has advantages in reducing the used bandwidth of a photo-electric element and restraining a large amount of the polarization mode dispersion and chromatic dispersion, which are generated in optical lines. However, the DP-QPSK has a disadvantage in that the receiving terminal becomes complex and the power consumption increases due to circuits of an analog-to-digital converter and a high-speed digital signal processing (DSP), which operate in a high-speed at the receiving terminal for the purpose of the polarization separation and signal restoration.

The directly receiving method has advantages in that the electronic circuits being used in the existing PSK can be used without any changes by passing an input signal with a modulated phase through an optical interferometer to make interference between neighboring bits and convert the input signal with a modulated phase to the signal with the modulated size. The directly receiving method is called as differential detection due to the usage of interference information of the neighboring bits. With two optical carriers and a signal that is modulated in QPSK, a symbol rate may be reduced to one quarter of a bit rate. Thus, such a method has an advantage in that the power consumption is reduced and the receiving terminal is simple. However, such a method has disadvantages in that both the chromatic dispersion and polarization mode dispersion, generated in optical lines, cannot be compensated because the method only uses the direct reception.

### SUMMARY

An optical transmitting and receiving apparatus and method reduces a required symbol rate compared to a transmission speed by using a plurality of optical carriers and a multi-level modulation manner, and includes a function for electrical dispersion compensation so as to restrain the influence of chromatic dispersion and polarization mode dispersion, which are generated in optical lines.

In one general aspect, an optical transmitting apparatus based on multicarrier differential phase shift keying includes: a multicarrier generator to output two or more optical signals, each of which has a different wavelength; two or more optical modulators to receive the two or more optical signals, respectively, which have been output from the multicarrier generator, wherein each of the two or more optical modulators modulates phases of the two or more received optical signals by electrical signals that are applied in pairs.

In another general aspect, an optical receiving apparatus based on multicarrier differential phase shift keying includes: two or more differential interferometers to receive two or more optical signals, respectively, and modulate sizes thereof; two or more photo-electric converters to convert, to electrical signals, the two or more optical signals that have been modulated in the two or more differential interferometers; and two or more electrical dispersion compensators to compensate pulse dispersion of the electrical signals that have been output from the two or more photo-electric converters.

In another general aspect, an optical transmitting method based on multicarrier differential phase shift keying includes: generating two or more optical signals, each of which has a different wavelength; and modulating phases of the two or more generated optical signals by electrical signals that are applied in pairs.

In another general aspect, an optical receiving method based on multicarrier differential phase shift keying includes: receiving two or more optical signals, respectively, and modulating sizes thereof; converting the two or more modulated optical signals to electrical signals; and compensating pulse dispersion of the electrical signals.

Other features and aspects may be apparent from the following detailed description, the drawings, and the claims.

### BRIEF DESCRIPTION OF THE DRAWINGS

FIG. 1 is a diagram illustrating an optical transmitting apparatus based on multicarrier differential phase shift keying according to an exemplary embodiment.

FIG. 2 is a diagram illustrating an optical receiving apparatus based on multicarrier differential phase shift keying according to an exemplary embodiment.

FIG. 3A is a diagram illustrating an example of optical signals generated in a multicarrier generator.

FIG. 3B is a diagram illustrating an example of multi-level optical signals modulated in optical modulators.

FIG. 4 is a diagram illustrating an example of modulating an optical signal in QPSK in an optical transmitting apparatus.

FIG. 5 is a diagram illustrating an example of restoring a QPSK signal, of which phase is modulated in an optical receiving apparatus.

FIG. 6A is a detailed diagram illustrating an electrical dispersion compensator of a FFE method according to an exemplary embodiment.

FIG. 6B is a detailed diagram illustrating an electrical dispersion compensator of a DFE method according to another exemplary embodiment.

FIG. 7A is an eye diagram before electrical dispersion compensation is performed according to an exemplary embodiment.

FIG. 7B is an eye diagram after electrical dispersion compensation is performed according to an exemplary embodiment.

FIG. 8 is a flowchart illustrating an optical transmitting method based on multicarrier differential phase shift keying according to an exemplary embodiment.

FIG. 9 is a flowchart illustrating an optical receiving method based on multicarrier differential phase shift keying according to an exemplary embodiment.

FIG. 10A is a flowchart illustrating an electrical dispersion compensating method of a FFE method according to an exemplary embodiment.

FIG. 10B is a flowchart illustrating an electrical dispersion compensating method of a DFE method according to another exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

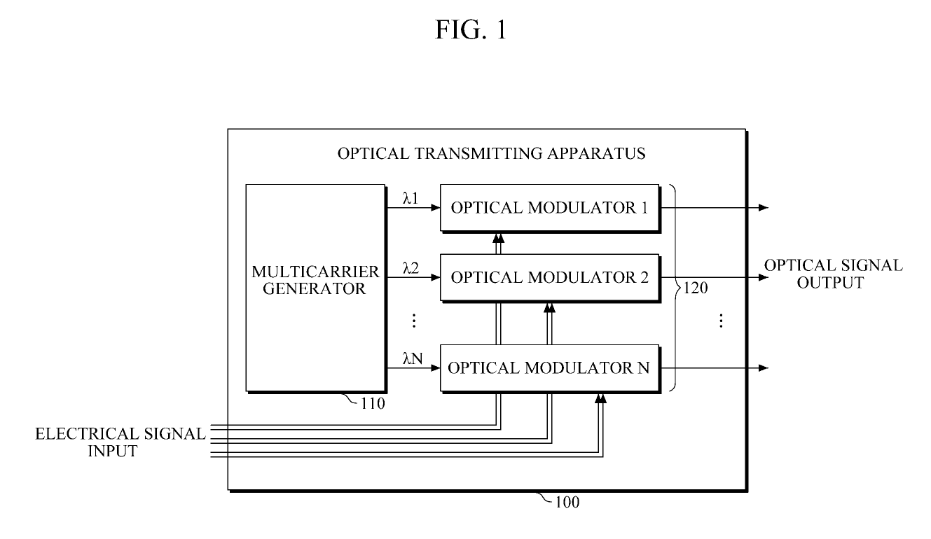

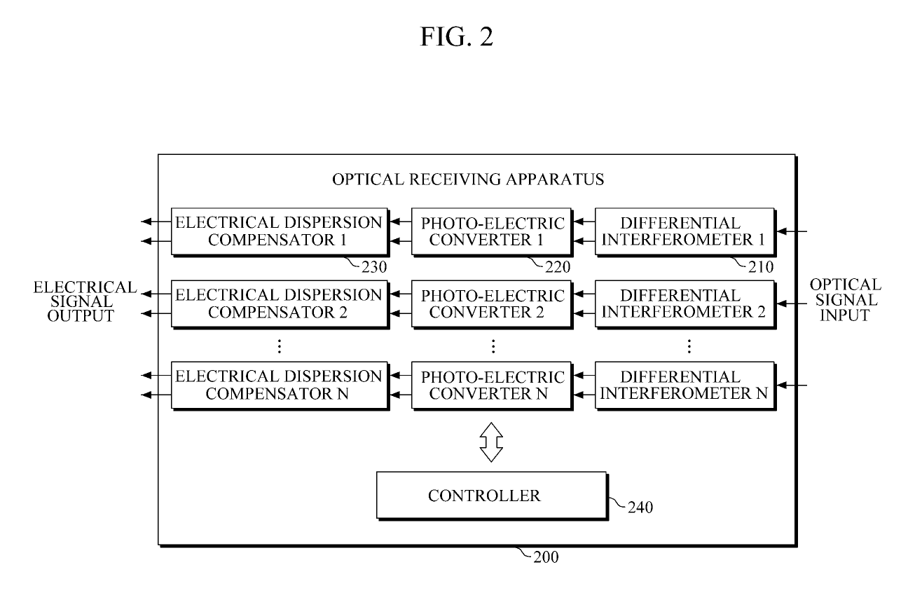

FIG. 1 is a diagram illustrating an optical transmitting apparatus based on multicarrier differential phase shift keying according to an exemplary embodiment, and FIG. 2 is a diagram illustrating an optical receiving apparatus based on multicarrier differential phase shift keying according to an exemplary embodiment. Here, the optical transmitting apparatus and the optical receiving apparatus may be implemented in one optical transceiver. However, the optical transmitting apparatus and the optical receiving apparatus are separately described below for convenience of description.

Referring to FIG. 1, an optical transmitting apparatus 100 includes: a multicarrier generator 110 that outputs two or more optical signals, each of which has a different wavelength; and two or more optical modulators 120 that receive each of the two or more optical signals that are output from the multicarrier generator 110, wherein each of the two or more optical modulators 120 modulates the phases of the received optical signals by the electrical signals that are applied in pairs.

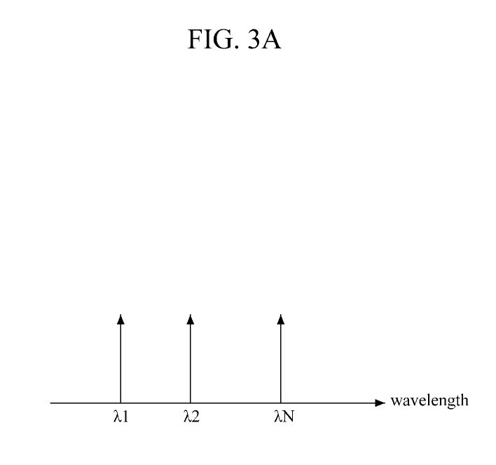

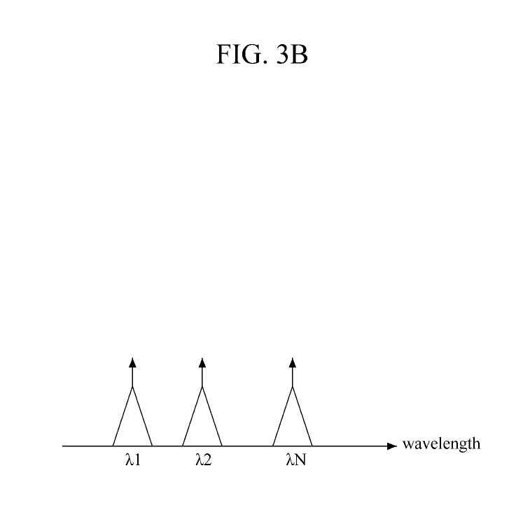

FIG. 3A is a diagram illustrating an example of optical signals generated in a multicarrier generator. A multicarrier generator 110 generates a number of optical signals with 1 to N of wavelengths as illustrated in FIG. 3A, and outputs the optical signals to the optical modulators 120, respectively.

Each of the optical modulators 120 modulates the phrases of the optical signals, which output from the multicarrier generator 110, according to the I electrical signal and the Q electrical signal and outputs multi-level optical signals. FIG. 3B is a diagram illustrating an example of the multi-level optical signals modulated in optical modulators. Here, in a case in which the number of the optical modulators 120 is N as illustrated in FIG. 1, the 2N number of electrical signals is input to the optical modulators 120. Each of the electrical signals applied in pairs may be binary signals of ‘0’ or ‘1’ or a signal that is composed of the predetermined number of levels.

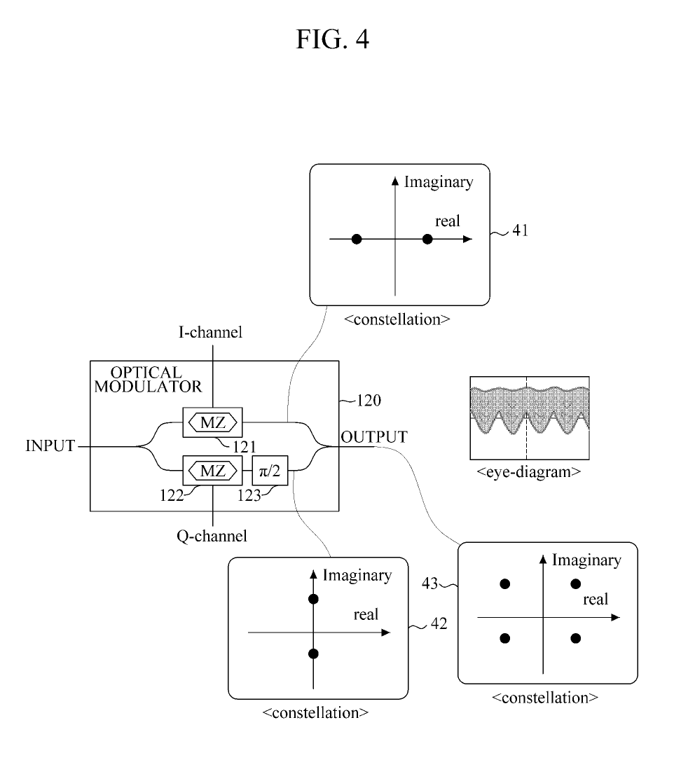

Also, it is assumed that the optical modulators 120 modulate a carrier to a QPSK signal, in which two bits are mapped to one symbol. If the bit rate is B, the symbol rate being used is reduced to B/(2×N). Thus, there is an economic advantage in that an optical transmitting apparatus may be implemented in the element with a reduced bandwidth. In addition, the optical modulators 120 are capable of pre-coding the optical signal with the modulated phase. A differential interferometer 210 is used in an optical receiving apparatus 200, which will be described later, thereby changing the data sequence. Thus, after the pre-coding at the optical transmitting apparatus 100, a correct data sequence may be restored in the optical receiving apparatus 200. The operations of the optical modulators 120 are more specifically examined with reference to FIG. 4 below.

The optical receiving apparatus 200 restores the received signals. Referring to FIG. 2, the optical receiving apparatus 200 includes: two or more differential interferometers 210 that receive the two or more optical signals and modulate their sizes; two or more photo-electric converters 220 that convert, to electric signals, the modulated signals that have been output from the two or more differential interferometers 210; and two or more electrical dispersion compensators 230 that compensate the pulse dispersion of the electrical signals that have been output from the photo-electric converters 220.

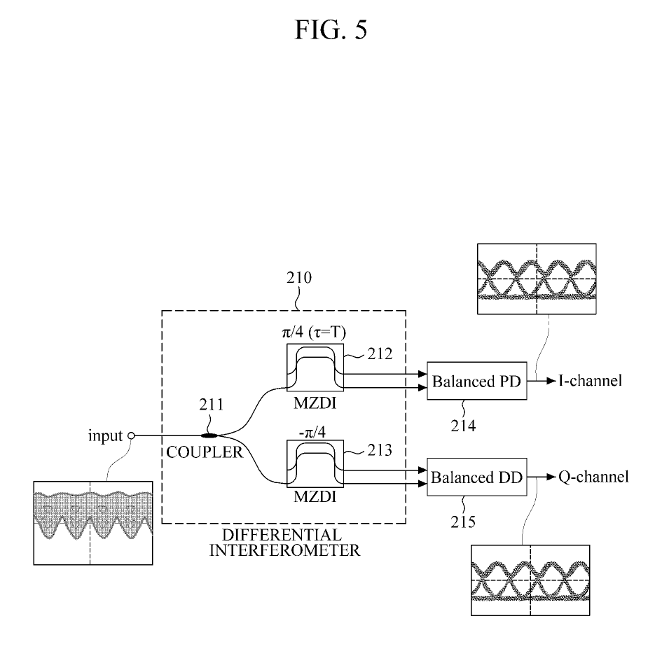

The delay time of each of the differential interferometer 210 is 2×N/B. In a case in which the interference between neighboring symbols is used, each of the two or more optical signals is converted into a binary signal, shown using 0 and 1, due to the phase difference between the neighboring symbols. Also, the differential interferometers 210 decode the modulated signals. The differential interferometers 210 are used, thereby changing the data sequence. Thus, a correct data sequence may be restored through a decoding process. The operations of the differential interferometers 210 are more specifically described with reference to FIG. 5 below.

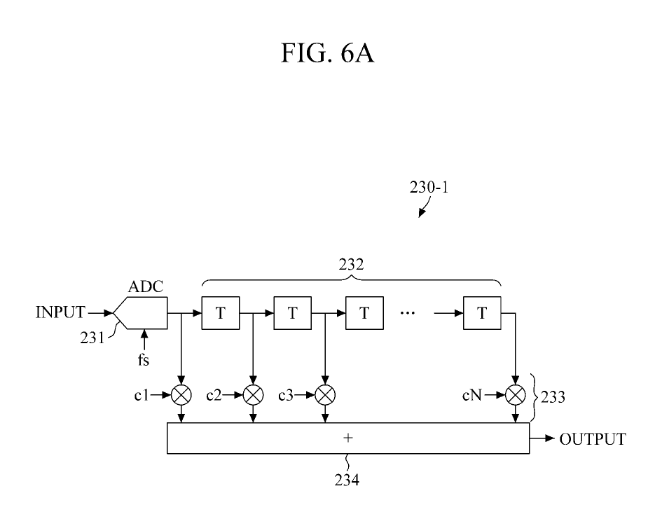

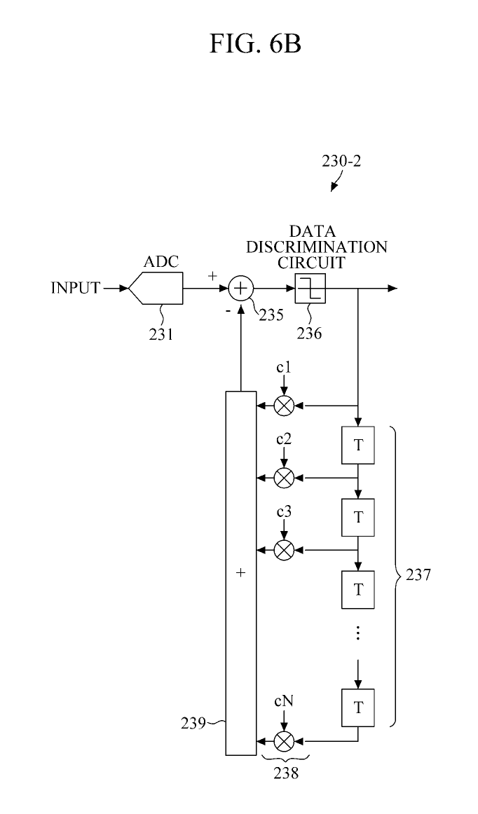

The electrical dispersion compensator 230 restores the pulse dispersion caused by chromatic dispersion and polarization mode dispersion, which are generated in optical transmitting lines, or compensates the pulse dispersion caused by an element's bandwidth limit. A signal, of which pulse dispersion has been compensated, is converted to the 2N number of the restored electrical data. The operations of the electrical dispersion compensator 230 are more specifically described with reference to FIGS. 6A and 6B below.

FIG. 4 is a diagram illustrating an example of modulating an optical signal in QPSK in an optical transmitting apparatus.

A binary NRZ signal having two levels, which are I-channel and Q-channel, is applied to an optical modulator 120. Here, in a case in which the optical modulator 120 is a Mach-Zehnder type, the Mach-Zehnder-typed optical modulators 121 and 122 modulate the input optical signal to a binary phase shift keying (BPSK) optical signal that has 0 and 180 degrees of phrases according to the applied binary signal. Here, if a delayer 123 turns the phase of one channel 90 degrees, a QPSK signal with four states each of which has 90 degrees of a phase difference is formed.

FIG. 5 is a diagram illustrating an example of restoring a QPSK signal, of which phase is modulated in an optical receiving apparatus.

A differential interferometer 210 separates an input signal into two signals at a coupler 211 and inputs each of the two signals to delay interferometers 212 and 213.

The delay interferometers 212 and 213 belong to a Mach-Zehnder delay-interferometer (MZDI). When delaying the path on one side as much as integral multiple of a symbol period T and combining the two signals, the destructive interference and constructive interference are generated at each of the ports. When balanced photo-detectors (PD) 214 and 215, each of which has two inputs, receive the destructive interference and the constructive interference, the NRZ signal is restored at an optical transmitting apparatus 100. The I-channel and the Q-channel all restore the electrical signals through the same processes and only have to generate +/−45 degrees of the phases of delay properties at the MZDI delay interferometers 212 and 213, respectively.

The electrical dispersion compensator 230 may be implemented in various forms. However, here, examples of feed forward equalization (FFE) and decision feedback equalization (DFE), illustrated in FIGS. 6A and 6B, respectively, are described.

FIG. 6A is a detailed diagram illustrating an electrical dispersion compensator of a FFE method according to an exemplary embodiment.

An electrical dispersion compensator 230-1 includes: an analog-to-digital converter (ADC) 231 that converts, to a digital signal, an electrical signal that has been output from a photo-electric converter 220; two or more delay elements 232 that delay the digital signal a predetermined time, which has been output from the ADC 231, and that are connected to each other in series; two or more multipliers 233 that multiply the signal that has been output from each of the delay elements 232 by a predetermined size of tap constant C; and an adder 234 that adds signals that have been output from the multipliers 233.

Here, the ADC 231 converts an analog signal to a digital signal at a sampling frequency fs. Also, the delay time T of each of the delay elements 232 may be defined as 1/fs.

FIG. 6B is a detailed diagram illustrating an electrical dispersion compensator of a DFE method according to another exemplary embodiment.

An electrical dispersion compensator 230-2 includes: an ADC 231 that converts, to a digital signal, an electrical signal that has been output from a photo-electric converter 220; a data discrimination circuit 236 that discriminates data of an input signal; two or more delay elements 237 that delay the digital signal a predetermined time, which has been output from the data discrimination circuit 236, and that are connected to each other in series; two or more multipliers 238 that multiply the signal that has been output from each of the delay elements 237 by a predetermined size of a tap constant C; an adder 239 that adds signals that have been output from the multipliers 238; and a subtractor 235 that inputs, to the data discrimination circuit 236, a signal that is acquired by subtracting the signal, output from the adder 239, from the signal that has been output from the ADC 231.

However, other than the FFE or DFE method, various compensation methods may be used, such as maximum likelihood sequence estimator (MLSE), etc.

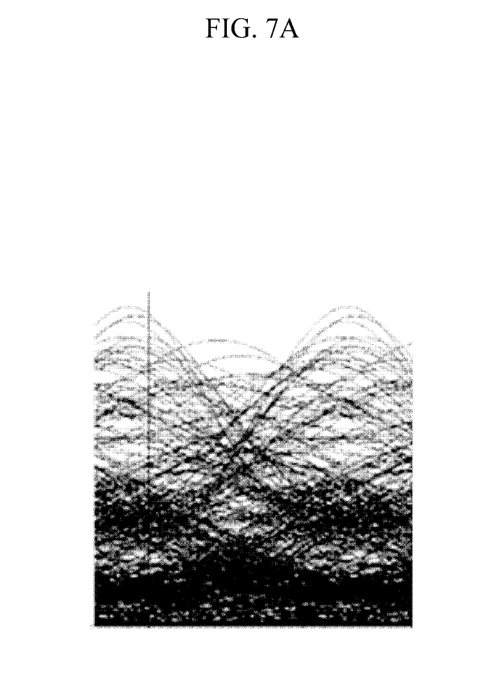

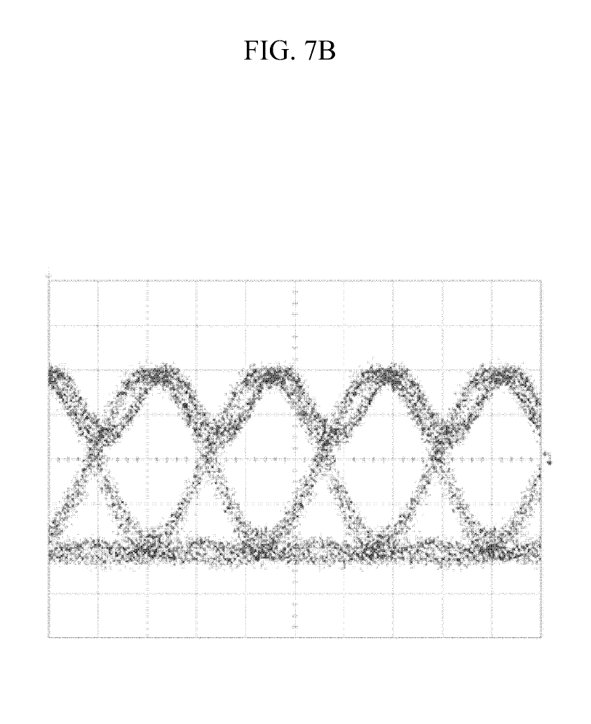

FIG. 7A is an eye diagram before electrical dispersion compensation is performed according to an exemplary embodiment, and FIG. 7B is an eye diagram after electrical dispersion compensation is performed according to an exemplary embodiment.

Referring to FIGS. 7A and 7B, a distorted signal may be compensated via electrical dispersion compensation so that a signal is capable of being transmitted not being affected by chromatic dispersion, polarization mode dispersion, a bandwidth limit, etc.

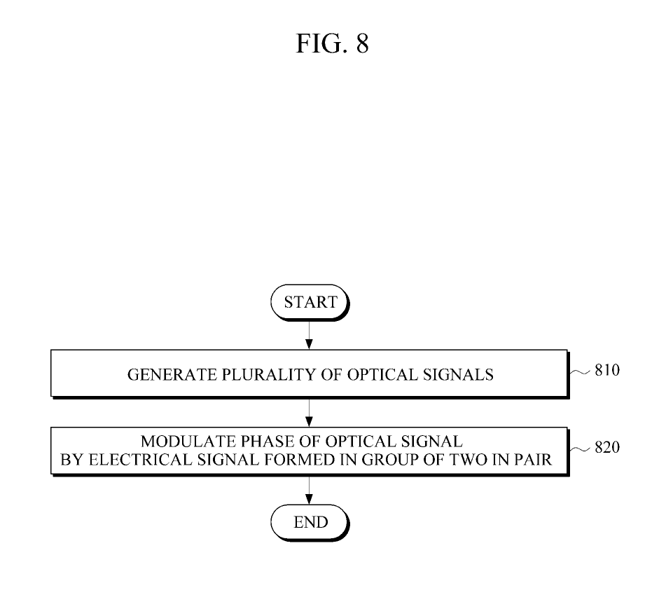

FIG. 8 is a flowchart illustrating an optical transmitting method based on multicarrier differential phase shift keying according to an exemplary embodiment.

An optical transmitting apparatus 100 generates two or more optical signals, each of which has a different wavelength, in 810. Then, the optical transmitting apparatus 100 modulates the phases of the two or more received optical signals by electrical signals that are applied in pairs in 820.

The optical transmitting apparatus 100 modulates the phases of the generated optical signals according to the I electrical signal and the Q electrical signal and outputs multi-level optical signals. Here, in a case in which the number of the optical signals is N as illustrated in FIG. 1, the 2N number of the electrical signals is input, wherein each of the electrical signals applied in pairs may be a binary signal of ‘0’ or ‘1’ or a signal that is composed of the predetermined number of levels. It is assumed that the optical transmitting apparatus 100 modulates a carrier to a QPSK signal, in which two bits are mapped to one symbol. If the bit rate is B, the symbol rate being used is reduced to B/(2×N). Thus, there is an economic advantage in that an optical transmitting method is implemented in the element with a reduced bandwidth. In addition, the optical transmitting apparatus 100 is capable of pre-coding the optical signal with the modulated phase. The differential-interference is used in an optical receiving apparatus 200, which will be described later, thereby changing the data sequence. Thus, after the pre-coding at the optical transmitting apparatus 100, a correct data sequence may be restored in the optical receiving apparatus 200.

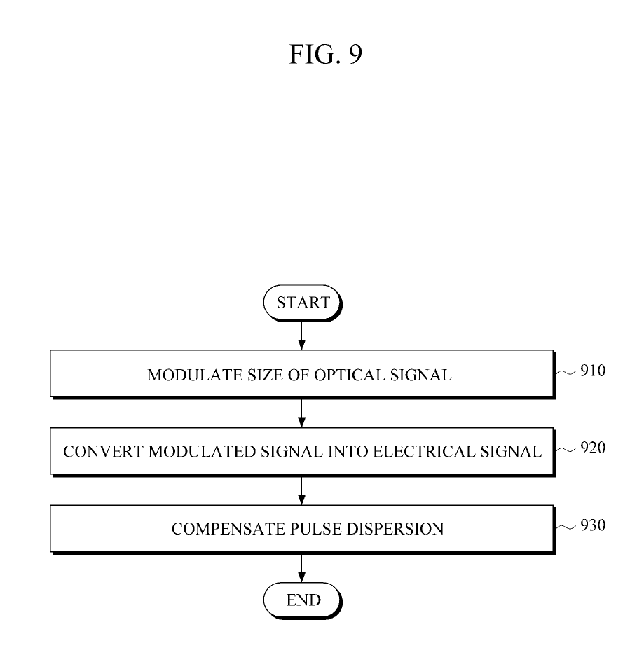

FIG. 9 is a flowchart illustrating an optical receiving method based on multicarrier differential phase shift keying according to an exemplary embodiment. An optical receiving apparatus 200 restores received signals. The optical receiving apparatus 200 receives the two or more optical signals and modulates their sizes in 910. In 920, the optical receiving apparatus 200 converts the two or more modulated signals to electrical signals. Also, the optical receiving apparatus 200 compensates the pulse dispersion of the electrical signals in 930.

In 910, the delay time is 2×N/B, and in a case in which the interference between neighboring symbols is used, each of the two or more optical signals is converted into a binary signal, shown using 0 and 1, due to the phase difference between the neighboring symbols. Also, the optical receiving method may further include decoding the modulated signals according to an exemplary embodiment. The differential-interference is used, thereby changing the data sequence. Thus, a correct data sequence may be restored through a decoding process.

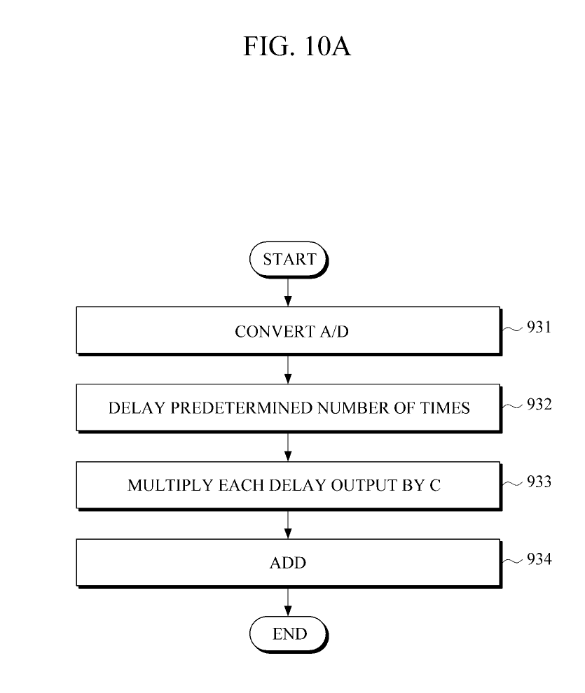

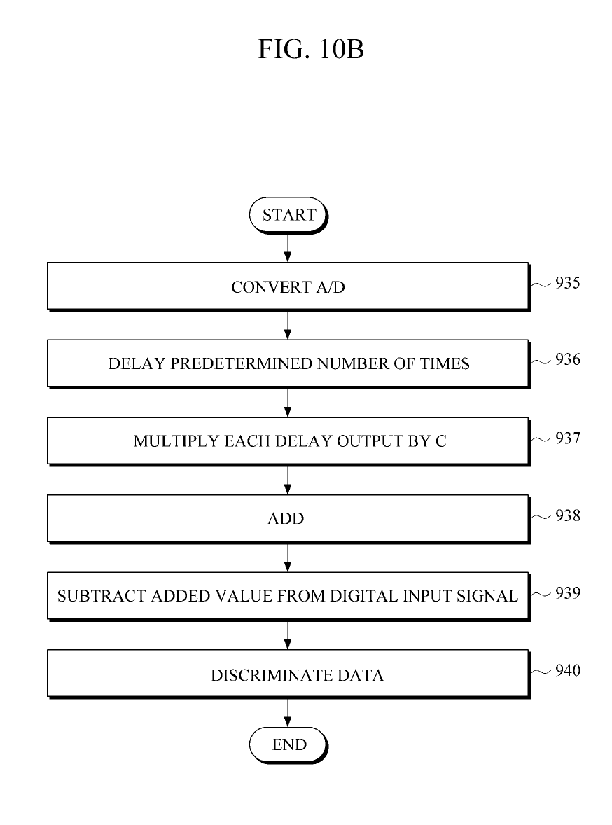

In 930, the pulse dispersion is restored by chromatic dispersion and polarization mode dispersion, which are generated in optical transmitting lines, or the pulse dispersion caused by an element's the bandwidth limit is compensated. The signal, of which pulse dispersion has been compensated, is converted to the 2N number of the restored electrical data. An operation 930 of compensating electrical dispersion is more specifically described with reference to FIGS. 10A and 10B below.

FIG. 10A is a flowchart illustrating an electrical dispersion compensating method of a FFE method according to an exemplary embodiment.

Referring to FIG. 10A, an electrical dispersion compensator 230-1 converts an electrical signal into a digital signal in 931. In 932, the electrical dispersion compensator 230-1 delays the digital signal a predetermined time, and sequentially delays the predetermined number of times of the digital signal according to two or more delay elements 232 connected to each other in series. The electrical dispersion compensator 230-1 multiplies the signal that has been output from each of the delay elements 232 by a predetermined size of a tap constant C in 933. The electrical dispersion compensator 230-1 adds signals that have been output from the multipliers 233.

Here, an analog signal is converted into a digital signal at a sampling frequency fs in 931. Also, the delay time T may be defined as 1/fs.

FIG. 10B is a flowchart illustrating an electrical dispersion compensating method of a DFE method according to another exemplary embodiment.

An electrical dispersion compensator 230-2 converts an electrical signal to a digital signal in 935, and delays the digital signal a predetermined time, which has been output in 936, wherein the digital signal is delayed by two or more delay elements 237 that are connected to each other in series.

An electrical dispersion compensator 230-2 multiplies, in 937, the signal that has been output from each of the delay elements 237 by a predetermined size of a tap constant C, and adds all the multiplied signals in 938. The electrical dispersion compensator 230-2 subtracts the added signal of the operation 938 from the digital signal of the operation 935 and discriminates the data in 940.

However, other than the FFE or DFE method, various compensation methods may be used, such as maximum likelihood sequence estimator (MLSE), etc.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An optical transmitting apparatus based on multicarrier differential phase shift keying, the optical transmitting apparatus comprising:
a multicarrier generator configured to output two or more optical signals, each of which has a different wavelength;
two or more optical modulators configured to receive the two or more optical signals, respectively, which have been output from the multicarrier generator, wherein each of the two or more optical modulators is configured to modulate phases of the two or more received optical signals by electrical signals that are applied in pairs.

2. The optical transmitting apparatus of claim 1, wherein each of the optical modulators is configured to receive the electrical signals that are applied in pairs, wherein each of the electrical signals is a binary signal or a signal that includes a predetermined number of levels.

3. The optical transmitting apparatus of claim 1, wherein the two or more optical modulators are configured to, respectively, pre-code the two or more optical signals with modulated phases.

4. An optical receiving apparatus based on multicarrier differential phase shift keying, the optical receiving apparatus comprising:
two or more differential interferometers configured to receive two or more optical signals, respectively, and modulate sizes thereof;
two or more photo-electric converters configured to convert, to electrical signals, the two or more optical signals that have been modulated in the two or more differential interferometers; and
two or more electrical dispersion compensators configured to compensate pulse dispersion of the electrical signals that have been output from the two or more photo-electric converters.

5. The optical receiving apparatus of claim 4, wherein the two or more differential interferometers are configured to convert the two or more optical signals into binary signals based on a phase difference between neighboring symbols.

6. The optical receiving apparatus of claim 4, wherein the two or more differential interferometers are configured to decode the two or more optical signals, respectively.

7. The optical receiving apparatus of claim 4, wherein the two or more electrical dispersion compensators comprise:
an analog-to-digital converter configured to convert, to digital signals, the electrical signals that have been output from the two or more photo-electric converters;
two or more delay elements configured to delay the digital signals a predetermined time, which have been output from the analog-to-digital converter, and be connected to each other in series;
two or more multipliers configured to multiply a signal that has been output from each of the delay elements by a predetermined size of a tap constant C; and
an adder configured to add signals that have been output, respectively, from the two or more multipliers.

8. The optical receiving apparatus of claim 4, wherein the electrical dispersion compensator comprises:
an analog-to-digital converter (ADC) configured to convert, to digital signals, the electrical signals that have been output from the two or more photo-electric converters;
a data discrimination circuit configured to discriminate data of an input signal;
two or more delay elements configured to delay the digital signals a predetermined time, which have been output from the data discrimination circuit, and be connected to each other in series;
two or more multipliers configured to multiply a signal that has been output from each of the delay elements by a predetermined size of a tap constant C;
an adder configured to add signals that have been output, respectively, from the two or more multipliers; and
a subtractor configured to input, to the data discrimination circuit, a signal acquired by subtracting a signal that has been output from the adder, from the digital signal that has been output from the ADC.

9. The optical receiving apparatus of claim 7, further comprising:
a controller configured to set and apply the tap constant C to the two or more multipliers.

10. An optical receiving method based on multicarrier differential phase shift keying, the optical receiving method comprising:
receiving two or more optical signals, respectively, and modulating sizes thereof;
converting the two or more modulated optical signals to electrical signals; and
compensating pulse dispersion of the electrical signals.

11. The optical receiving method of claim 10, wherein the converting of the two or more modulated optical signals to electrical signals comprises converting the two or more optical signals into binary signals based on a phase difference between neighboring symbols.

12. The optical receiving method of claim 10, further comprising:
decoding the two or more optical signals.

13. The optical receiving method of claim 10, wherein the compensating of the pulse dispersion of the electrical signals comprises:
converting the electrical signals to digital signals;
delaying the digital signals a predetermined time by two or more delay elements connected to each other in series ;
multiplying a signal that has been output from each of the delay elements by a predetermined size of a tap constant C; and
adding multiplied signals.

14. The optical receiving method of claim 10, wherein the compensating of the pulse dispersion of the electrical signals comprises:
converting the electrical signals to digital signals;
delaying the digital signals a predetermined time by two or more delay elements connected to each other in series;
multiplying a signal that has been output from each of the delay elements by a predetermined size of a tap constant C;
adding multiplied signals;
subtracting the added signals from the digital signals; and
discriminating data of an input signal.

15. The optical receiving apparatus of claim 13, further comprising:
setting the tap constant C.
